(19) United States
(12) Patent Application Publication
(10) Pub. No.: US 2006/0020690 A1
(43) Pub. Date: Jan. 26, 2006

(54) Network topology and method of operation for a playback system in a digital cinema network

(76) Inventors: Martin John Richards, Redwood City, CA (US); Makarand Prabhakar Karanjkar, Fremont, CA (US); Douglas Evan Mandell, San Francisco, CA (US); Dean Carleton Bullock, San Rafael, CA (US); Pierre-Anthony Stivell Lemieux, San Mateo, CA (US); Gopi Lakshminarayanan, Fremont, CA (US)

Correspondence Address: GALLAGHER & LATHROP, A PROFESSIONAL CORPORATION, 601 CALIFORNIA ST, SUITE 1111, SAN FRANCISCO, CA, 94108, US

(21) Appl. No.: 10/870,698

(22) Filed: Jun. 17, 2004

(51) Int. Cl. G06F 15/177

(52) U.S. Cl. 709/221

(57) ABSTRACT

The installation, maintenance and administration of digital cinema playback systems is facilitated by devices within the playback systems having operator-actuated controls that are used to specify a unique identifier for each playback system in a digital cinema complex. The identifier for a system is used to establish a set of network addresses for that playback system from which device addresses are assigned automatically. Subsequent communication between devices within a playback system use the assigned device addresses. These communications are used to alter the operation of devices, and for devices to publish the existence of and the need for specified services.

### TECHNICAL FIELD

The present invention pertains generally to digital cinema and pertains more specifically to methods and devices for a use in a network of equipment in a digital cinema system.

### BACKGROUND ART

The concept of “digital cinema” includes the production, delivery and presentation of aural/visual material in auditoriums or theatres using digital technology. Digital cinema programs typically are distributed in a compressed and encrypted form on physical media such as DVD-ROM, tape or computer hard drives and can in principle be distributed by electronic transmission using satellite or other broadband communication paths.

Digital cinema playback systems control the processes required to make a digital cinematic presentation. These processes include receiving and storing the digital cinema program, decompressing and deciphering it into digital video and audio data streams that can be processed by digital content decoders, decoding the content of the data streams to obtain signals that may be used drive video displays and audio amplifiers, and controlling other facilities such as curtains or theatre lighting that are found in a theatre auditorium.

Typical digital cinema playback systems include several pieces of equipment that communicate with one another through an electrical network that is similar to many networks that are used to interconnect computers. These networks often conform to a standard that is commonly known as Ethernet, which is described in the IEEE 802.3 standard, using a communication protocol known as the Transmission Control Protocol/Internet Protocol (TCP/IP). This choice of network and protocol can simplify the task of implementing a digital cinema playback system because the electrical and logical interfaces and procedures needed to use them are readily available and have relatively low cost.

Unfortunately, the knowledge and skills needed to install, maintain and administer networks of this type are not usually found in the people who have typically installed, maintained and administered theatre equipment. People who have the necessary knowledge and skills are often in short supply and usually command high salaries. This has increased the cost and time needed to install digital cinema systems and often increases the cost and time needed to respond to and correct errors that arise as the systems are used. As a result, the acceptance of digital cinema by theatre owners has not been as high or as rapid as it could have been had the installation, maintenance and operation of digital cinema playback systems been easier and cheaper to accomplish.

### DISCLOSURE OF INVENTION

It is an object of the present invention to simplify the installation, maintenance and administration of networks of equipment in digital cinema playback systems.

According to one aspect of the present invention, a server device in a digital cinema playback system receives an identifier specified by one or more operator-actuated controls that designates a device for displaying a digital cinematic presentation, establishes a set of network device addresses in response to the identifier, selects an address from the set of network device addresses, assigns the selected network device address to a client device in the plurality of devices, and sends a notification of the selected network device address through the network to the client device, and uses the selected address to instruct the client device through the network to alter its operation, thereby controlling one or more features of the digital cinematic presentation.

According to another aspect of the present invention, a client device in a digital cinema playback system receives an identifier from one or more operator-actuated controls that designates a device for displaying a digital cinematic presentation, sends a notification through the network to a server device in the plurality of devices that conveys the identifier, uses an interim address to receive a notification from the server device through the network that conveys a network device address, and uses the network device address to receive instructions from the network and, in response, alters its operation to control one or more features of the digital cinematic presentation.

The various features of the present invention and its preferred embodiments may be better understood by referring to the following discussion and the accompanying drawings in which like reference numerals refer to like elements in the several figures. The contents of the following discussion and the drawings are set forth as examples only and should not be understood to represent limitations upon the scope of the present invention.

### BRIEF DESCRIPTION OF DRAWINGS

FIG. 1 is a schematic block diagram of a digital cinema network.

FIGS. 2-5 are schematic block diagrams of digital cinema playback systems.

FIG. 6 is a diagram showing steps in a method for operating server and client devices in a playback system network.

FIG. 7 is a schematic block diagram of a device that may be used to implement various aspects of the present invention.

### MODES FOR CARRYING OUT THE INVENTION

### Introduction

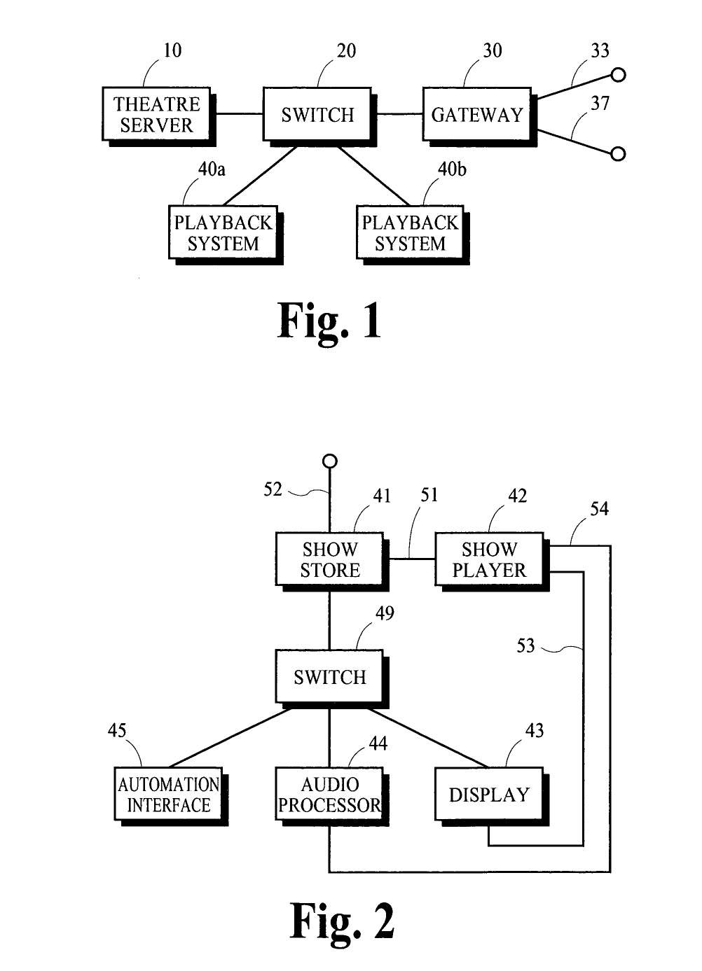

FIG. 1 illustrates a digital cinema network that has multiple playback systems. A typical system has a playback system for each auditorium in a digital cinema theatre complex; however, the network and equipment may be organized and installed in a wide variety of ways including, for example, multiple playback systems in a single auditorium with one or more screens. This latter arrangement allows multiple digital cinema programs to be presented simultaneously in one auditorium.

Referring to FIG. 1, a theatre management server 10, a gateway 30, and playback systems 40a, 40b are connected to one another by a network using a theatre network switch 20. Preferably, a Gigabit Ethernet or 1000BASE-T network is used. The theatre management server 10 performs a variety of services including administration and overall control of the playback systems 40a, 40b in the digital cinema network. Examples of these services are discussed briefly below. The gateway 30 is optional and provides a communication link between the digital cinema network and one or more communication paths such as a satellite communication link 33 or a terrestrial wideband network 37. Alternatively, the gateway may be incorporated into the switch 20 to provide a single switch/gateway or router device. The communication paths may be used to deliver information such as cinema promotional material and digital cinema program decryption keys. Virtual private networking or similar functions may be provided to better protect sensitive information such as decryption keys.

### Theatre Management Server

In a typical installation, the theatre management server 10 provides services that are important to the operation and management of a theatre but it need not provide any services or perform any functions that are essential to the present invention. In one implementation, the theatre management server 10 provides services that allow personnel to configure and test theatre systems and equipment including playback systems, collect information describing the operation of the theatre systems, diagnose the cause of system malfunctions, receive and manage media content and decryption keys, assemble the media content into cinematic presentations or “shows,” schedule and control the presentation of the shows, and assist with the management of licenses for media content including Digital Rights Management (DRM).

### Playback System

In a preferred implementation of the digital cinema network, each playback system 40 is functionally independent of all other playback systems in the network. A respective playback system 40 may operate to provide a digital cinematic presentation without requiring services from equipment in any other playback system. Each respective playback system has equipment with one or more operator-actuated controls such as thumb-wheel or rotary switches, for example, that allow an operator to specify a unique identifier for the respective playback system. The operator-actuated controls are used to control the assignment of network IP addresses to the devices in each playback system.

The playback systems may be implemented in a variety of ways. A few ways are described in the following paragraphs.

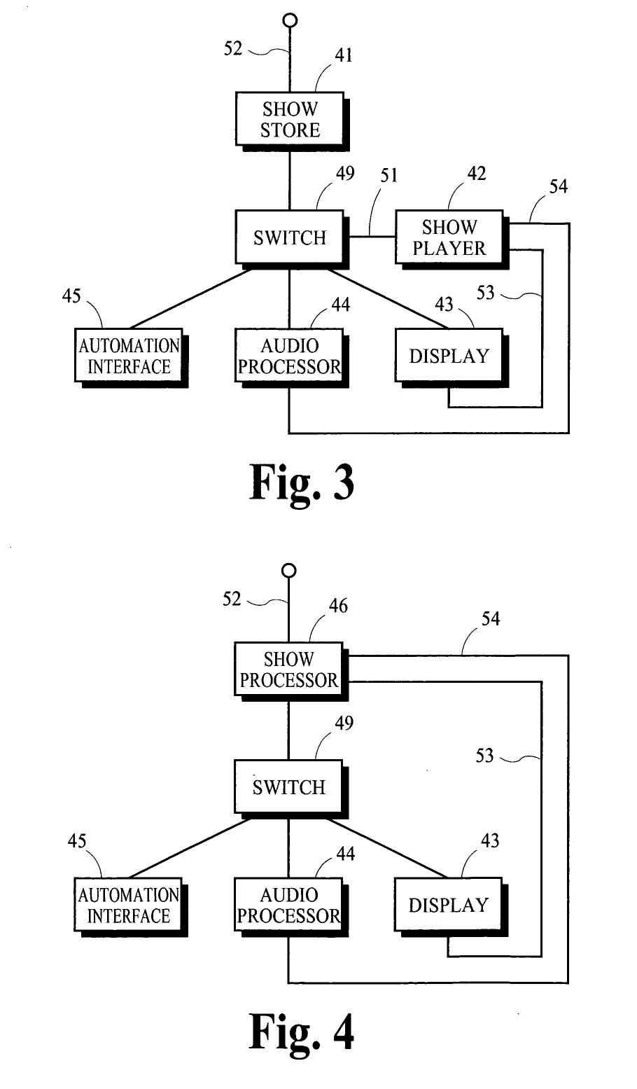

The schematic block diagram shown in FIG. 2 illustrates one implementation of a playback system 40 that includes a show store 41, a show player 42, a display 43, an audio processor 44, an automation interface 45, and a switch 49. The switch 49 provides network connections between all of these devices except the show player 42. Communication paths 51, 53, 54 directly connect the show player 42 to the show store 41, the display 43 and the audio processor 44, respectively.

The show store 41 is connected to the network switch 20 through communication path 52 and acts as a file server to receive and store one or more digital cinema programs. The show store 41 may store show configurations, show schedules, and information related to licensing, DRM and encryption. In a preferred implementation, the show store 41 also acts as a Dynamic Host Configuration Protocol (DHCP) server to control the assignment of network IP address to devices in the playback system 40 and may implement Service Location Protocol (SLP) user and service agents to facilitate the provision of services within the playback system. DHCP and SLP are described in Internet Requests for Comments (RFC) 1541 and RFC 2165, respectively. The show store 41 extracts information from the stored programs, reformats the extracted information into an encoded representation that facilitates subsequent processing, and provides the encoded representation to the show player 42. Preferably, the encoded information is conveyed from the show store 41 to the show player 42 by a wideband communication path 51 such as a dedicated 1000BASE-T Ethernet path that connects directly between these two devices. In a typical implementation, the encoded representation conveys video information encoded according to some standard such as the MPEG-2 standard that is described in the International Standards Organization (ISO) Motion Picture Experts Group (MPEG) documents ISO/IEC 13818-1 through 13818-9, or the JPEG-2000 standard described in ISO/IEC 15444:2000, and conveys audio information that may be encoded as Pulse Code Modulation (PCM) data, MetaAudio Enhanced PCM data or data generated by an encoding process such as MetaAudio Dolby F. An example of a suitable show store 41 is the Dolby Show Store DSS100, available from Dolby Laboratories, San Francisco, Calif.

The show player 42 is a digital content decoder that decodes this encoded representation to obtain digital video and digital audio information, which are provided to the display 43 and the audio processor 44, respectively, through communication paths 53, 54. The encoded representation may be encrypted. If it is encrypted, the show player 42 uses an appropriate video-content decryption key to decipher the video content. Preferably, a technique is used such as that described in the Federal Information Processing Standards (FIPS) Publication 197 with key generation and exchange provided by techniques such as those described in RSA Cryptography Standard PKCS #1 v2.1 or in the IEEE 1363-2000 standard. The show store 41 receives the appropriate video-content decryption key from the theatre management server 10, which may store this key and subsequently pass it to the show player 42 as needed or which may pass the key to the show player 42 without storing it.

In one implementation, the show store 41 receives an encrypted version of the video-content decryption key that was encrypted using a public key uniquely associated with the show player 42. The show player 42 deciphers the encrypted video-content decryption key using its own private key, uses the video-content decryption key to decipher and decode the video information as required and, if desired, encrypts the decoded video information for subsequent delivery to the display 43. The encryption may conform to some standard or other specification such as the proposed Society of Motion Picture and Television Engineers (SMPTE) DC28.4 standard or it may conform to proprietary processes that are compatible with the display 43. An example of a suitable show player 42 is the Dolby Show Player, DSP100, available from Dolby Laboratories, San Francisco, Calif.

The display 43 receives the decoded video information from the show player 42, deciphers the information if necessary, and presents the video information for viewing. The display may be essentially any device that is capable of presenting the video information such as a liquid crystal display (LCD) panel or a projector that can project an image onto a screen or other display medium. Preferably, the decoded video information is conveyed directly from the show player 42 to the display 43 by a wideband communication path 53 in a form that is compliant with the High Definition Serial Data Interface (HD-SDI) as described in the SMPTE 292M standard. An example of a suitable display 43 is the model DP100 projector available from Barco N.V., Pres. Kennedypark 35, 8500 Kortrijk, Belgium.

The audio processor 44 receives the audio information from the show store 42, decodes the audio information if necessary, and applies filtering and equalization as desired to generate a signal that may be amplified for presentation by loudspeakers or other acoustic transducers. An example of a suitable audio processor 44 is the cinema sound processor model CP650, available from Dolby Laboratories, San Francisco, Calif. Preferably, the audio information is conveyed from the show player 42 to the audio processor 44 by a wideband communication path 54 that directly connects between these two devices and conforms to the SMPTE 276M standard.

The automation interface 45 generates signals in response to commands received through the switch 49 to control auditorium lighting, curtains and other components in a theatre automation system. An example of a suitable automation interface is the Network Automation Interface NA10, available from Dolby Laboratories, San Francisco, Calif.

The switch 49 switches traffic within the network of the playback system 40. In a preferred implementation, it supports a 1000 Mbs or faster network such as a 1000BASE-T network.

The schematic block diagram shown in FIG. 3 illustrates another implementation of a playback system 40 that is similar to the implementation shown in FIG. 2 except that a network connection to the show player 42 replaces the dedicated wideband communication path 51 between the show player 42 and the show store 41. This implementation imposes much higher bandwidth requirements upon the switch 49.

The schematic block diagram shown in FIG. 4 illustrates yet another implementation of a playback system 40 that is similar to the implementation shown in FIG. 2 except that the show store 41 and the show player 42 are incorporated into the same device, which is shown in the figure as show processor 46. This implementation imposes about the same bandwidth requirements upon the network and the switch 49 as that imposed by the implementation shown in FIG. 2.

The schematic block diagram shown in FIG. 5 illustrates another implementation of a playback system 40 that is similar to the implementation shown in FIG. 2 except that the show player 42 and the display 43 are incorporated into the same device, which is shown in the figure as display processor 47. This implementation imposes about the same bandwidth requirements upon the network and the switch 49 as that imposed by the implementation shown in FIG. 2.

### Playback System Operation

Preferably one and only one device in each playback system has one or more operator-actuated controls that are used to uniquely identify each playback system. For example, the show player 42 may have one or more thumbwheel or rotary switches that may be operated to specify an identification for the playback system. In effect, the operator-actuated controls in each playback system identify the display 43 or display device in the respective playback system that displays a digital cinematic presentation. The operator-actuated controls could be provided on the display 43 itself; however, it may be more convenient to provide these controls on equipment that is not required to be located at the presentation site. This would allow the equipment with the operator-actuated controls for all playback systems in a theatre complex to be centrally located. The show store 41 and the show player 42, for example, may be centrally located if desired. The following examples assume the operator-actuated controls are provided on the show player 42.

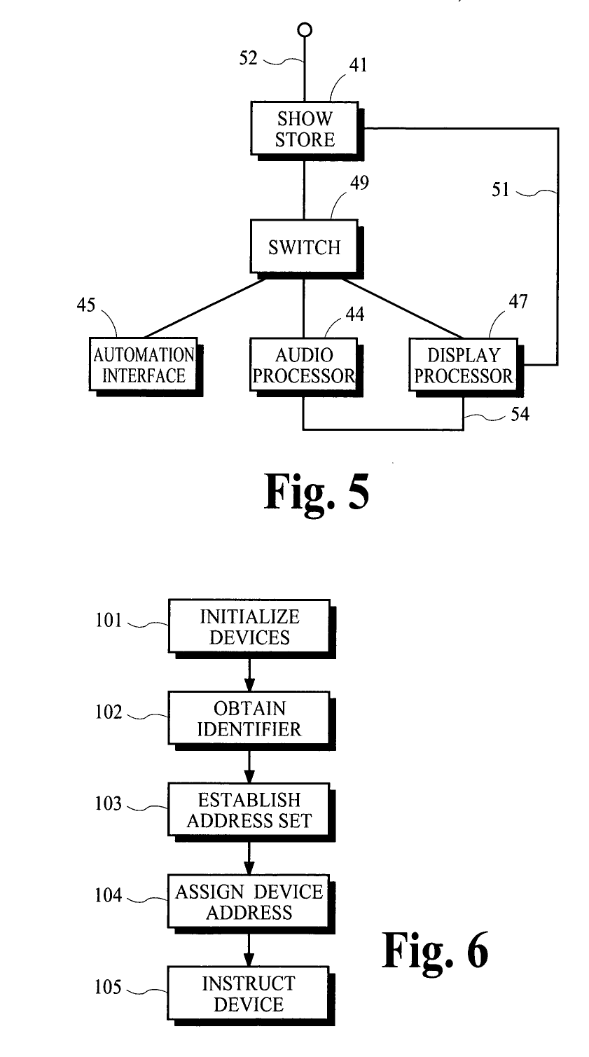

The show store 41 controls the assignment of network IP addresses to equipment in its respective playback system. This may be accomplished by the method steps shown in FIG. 6. One way of performing these steps is as follows:
Step 101. The show store and the store player are started. If these devices are implemented by program-controlled processors, this may be done by “booting” the processors.
Step 102. The show store obtains the identifier specified by operator-actuated controls. This may be done in a variety of ways. One way is for the show store and the show player to each assume a respective interim network IP address such as 192.168.0.1 and 192.168.0.2, respectively. Using the interim addresses, the show store sends a command to the show player requesting the identifier specified by its operator-actuated controls. In response to the request, the show player returns an indication of the identifier specified by the operator-actuated controls.
Step 103. Using the identifier, the show store establishes a set of network IP addresses from which device addresses may be assigned. This may be done in a variety of ways. One way establishes the set of addresses to be the IP address space defined by 192.168.1D.### where ID is the identifier specified by the operator-actuated controls and ### is any number in the range from 0 to 255. If this method is used, preferably the ID is constrained to not equal zero to avoid conflicts with the interim addresses used above in Step 102. In a preferred implementation, the show store assigns to itself a network IP address that is selected from the set of addresses.
Step 104. The show store assigns to the show player another network IP address that is selected from the set of addresses. This may be done by causing the show player to request DHCP services for assignment of an IP address. The show store may also assign network IP addresses to other devices in the playback system network by selecting respective addresses from the set of addresses. This may be done by causing the other devices to request DHCP services for assignment of addresses.
Step 105. Subsequent communication between equipment in the playback system may use the assigned network IP addresses. This communication may include instructions from a first device to a second device that causes the second device to alter its operation, thereby controlling one or more features of a digital cinematic presentation.

The show store 41 of a respective playback system 40 may act as a network router that provides a two-way communication link between devices in the respective playback system and other devices elsewhere in the digital cinema network; however, preferably the show store does not forward requests for network IP addresses outside the playback system. In addition, the show store in a respective playback system preferably does not assign network IP addresses to devices in the digital cinema network that are outside the respective playback system.

The installation, maintenance and administration of a playback system may be facilitated by having equipment in each system notifying one another of the need and availability of various services. For example, the show store 42 may issue a notice that it requires the services of an automation interface that is capable of controlling theatre assets such as curtains and lights in an auditorium. In response, the automation interface 45 in the same or another playback system may reply with a notice that it is capable of providing the requested service. The reply could include its dynamically assigned network IP address together with other information that more fully describes its capabilities. These features may be implemented using the SLP mentioned above.

### Implementation

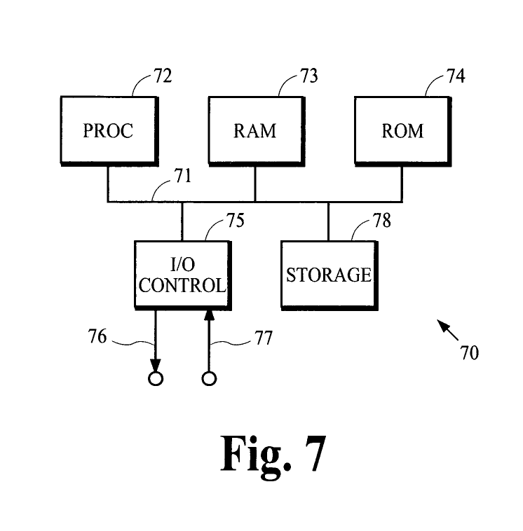

Devices that incorporate various aspects of the present invention may be implemented in a variety of ways including software for execution by a computer or some other device that includes more specialized components such as digital signal processor (DSP) circuitry coupled to components similar to those found in a general-purpose computer. FIG. 7 is a schematic block diagram of a device 70 that may be used to implement aspects of the present invention. The processor 72 provides computing resources. RAM 73 is system random access memory (RAM) used by the processor 72 for processing. ROM 74 represents some form of persistent storage such as read only memory (ROM) for storing programs needed to operate the device 70 and possibly for carrying out various aspects of the present invention. I/O control 75 represents interface circuitry to receive and transmit signals by way of the communication channels 76, 77. In the embodiment shown, all major system components connect to the bus 71, which may represent more than one physical or logical bus; however, a bus architecture is not required to implement the present invention.

In embodiments implemented by a general purpose computer system, additional components may be included for interfacing to devices such as a keyboard or mouse and a display, and for controlling a storage device 78 having a storage medium such as magnetic tape or disk, or an optical medium. The storage medium may be used to record programs of instructions for operating systems, utilities and applications, and may include programs that implement various aspects of the present invention. Preferably, the computer system is tolerant to hardware failures. One way in which this may be done is to provide redundant components such as dual power supplies and redundant storage devices, and to use an operating system that is capable of detecting and reacting to faults.

The functions required to practice various aspects of the present invention can be performed by components that are implemented in a wide variety of ways including discrete logic components, integrated circuits, one or more ASICs and/or program-controlled processors. The manner in which these components are implemented is not important to the present invention.

Software implementations of the present invention may be conveyed by a variety of machine readable media such as baseband or modulated communication paths throughout the spectrum including from supersonic to ultraviolet frequencies, or storage media that convey information using essentially any recording technology including magnetic tape, cards or disk, optical cards or disc, and detectable markings on media including paper.

1. A method for operating a server device in a plurality of devices that are connected to one another by a network in a digital cinema playback system, wherein the method comprises:
receiving an identifier specified by one or more operator-actuated controls that designates a device for displaying a digital cinematic presentation;
establishing a set of network device addresses in response to the identifier;
selecting an address from the set of network device addresses, assigning the selected network device address to a client device in the plurality of devices, and sending a notification of the selected network device address through the network to the client device; and
using the selected address to instruct the client device through the network to alter its operation, thereby controlling one or more features of the digital cinematic presentation.

2. The method of claim 1 that comprises:
receiving a notification through the network from the client device that conveys the identifier; and
using an interim address to send a notification of the selected network device address through the network to the client device.

3. The method of claim 1 that comprises sending a notification of the identifier through the network to another client device in the plurality of devices.

4. The method of claim 1 that comprises:
receiving a notification through the network from a processing device in the plurality of devices that identifies a characteristic of the device;
associating the characteristic with a respective network device address of the processing device;
receiving a request through the network for an address of a device that has the characteristic; and
in response to the request, sending a notification through the network that conveys the respective network device address of the processing device.

5. The method of claim 1 wherein the network connecting the plurality of devices in the digital cinema playback system constitutes a sub-network that is part of a digital cinema network comprising a plurality of digital cinema playback systems, wherein the server device provides a communication link between the sub-network and other parts of the digital cinema network, and wherein the method comprises performing the selecting, assigning and sending of the selected network device address in response to a request received from a device in the plurality of devices that are connected by the sub-network but not in response to a request received from a device in a part of the digital cinema network other than the sub-network.

6. The method of claim 1 wherein the network connecting the plurality of devices in the digital cinema playback system constitutes a sub-network that is part of a digital cinema network comprising a plurality of digital cinema playback systems, wherein the server device provides a communication link between the sub-network and other parts of the digital cinema network, and wherein the method comprises blocking requests for network device addresses but forwarding at least some of all other types of requests between the sub-network and the other parts of the digital cinema network.

7. A method for operating a client device in a plurality of devices that are connected to one another by a network in a digital cinema playback system, wherein the method comprises:
receiving an identifier from one or more operator-actuated controls that designates a device for displaying a digital cinematic presentation;
sending a notification through the network to a server device in the plurality of devices that conveys the identifier;
using an interim address to receive a notification from the server device through the network that conveys a network device address; and
using the network device address to receive instructions from the network and, in response, altering its operation to control one or more features of the digital cinematic presentation.

8. The method of claim 7 that comprises:
receiving instructions from the network to request an address;
sending a request for the address through the network in response to the instructions; and
receiving a notification of the network device address from the network.

9. The method of claim 7 that comprises:
sending a request through the network for an address of a device in the plurality of devices that has a characteristic;
receiving a notification from the network that conveys a respective network device address of a device that has the characteristic; and
using the respective network device address to send a request through the network to the device that causes a specified function to be performed by one of the devices in the plurality of devices.

10. The method of claim 7 that comprises sending a notification through the network that identifies one or more characteristics of the client device.

11. A medium conveying a program of instructions that is executable by a device to perform a method for operating a server device in a plurality of devices that are connected to one another by a network in a digital cinema playback system, wherein the method comprises:
receiving an identifier specified by one or more operator-actuated controls that designates a device for displaying a digital cinematic presentation;
establishing a set of network device addresses in response to the identifier;
selecting an address from the set of network device addresses, assigning the selected network device address to a client device in the plurality of devices, and sending a notification of the selected network device address through the network to the client device; and
using the selected address to instruct the client device through the network to alter its operation, thereby controlling one or more features of the digital cinematic presentation.

12. The medium of claim 11, wherein the method comprises:
receiving a notification through the network from the client device that conveys the identifier; and
using an interim address to send a notification of the selected network device address through the network to the client device.

13. The medium of claim 11, wherein the method comprises sending a notification of the identifier through the network to another client device in the plurality of devices.

14. The medium of claim 11, wherein the method comprises:
receiving a notification through the network from a processing device in the plurality of devices that identifies a characteristic of the device;
associating the characteristic with a respective network device address of the processing device;
receiving a request through the network for an address of a device that has the characteristic; and
in response to the request, sending a notification through the network that conveys the respective network device address of the processing device.

15. The medium of claim 11 wherein the network connecting the plurality of devices in the digital cinema playback system constitutes a sub-network that is part of a digital cinema network comprising a plurality of digital cinema playback systems, wherein the server device provides a communication link between the sub-network and other parts of the digital cinema network, and wherein the method comprises performing the selecting, assigning and sending of the selected network device address in response to a request received from a device in the plurality of devices that are connected by the sub-network but not in response to a request received from a device in a part of the digital cinema network other than the sub-network.

16. The medium of claim 11 wherein the network connecting the plurality of devices in the digital cinema playback system constitutes a sub-network that is part of a digital cinema network comprising a plurality of digital cinema playback systems, wherein the server device provides a communication link between the sub-network and other parts of the digital cinema network, and wherein the method comprises blocking requests for network device addresses but forwarding at least some of all other types of requests between the sub-network and the other parts of the digital cinema network.

17. A medium conveying a program of instructions that is executable by a device to perform a method for operating a client device in a plurality of devices that are connected to one another by a network in a digital cinema playback system, wherein the method comprises:
receiving an identifier from one or more operator-actuated controls that designates a device for displaying a digital cinematic presentation;
sending a notification through the network to a server device in the plurality of devices that conveys the identifier;
using an interim address to receive a notification from the server device through the network that conveys a network device address; and
using the network device address to receive instructions from the network and, in response, altering its operation to control one or more features of the digital cinematic presentation.

18. The medium of claim 17, wherein the method comprises:
receiving instructions from the network to request an address;
sending a request for the address through the network in response to the instructions; and
receiving a notification of the network device address from the network.

19. The medium of claim 17, wherein the method comprises:
sending a request through the network for an address of a device in the plurality of devices that has a characteristic;
receiving a notification from the network that conveys a respective network device address of a device that has the characteristic; and
using the respective network device address to send a request through the network to the device that causes a specified function to be performed by one of the devices in the plurality of devices.

20. The medium of claim 17, wherein the method comprises sending a notification through the network that identifies one or more characteristics of the client device.
